(19) United States
(12) Patent Application Publication
(10) Pub. No.: US 2011/0099898 A1
(43) Pub. Date: May 5, 2011

(54) METHOD TO STIMULATE CARBON FIXATION IN PLANTS WITH AN AQUEOUS SOLUTION OF OLIGO-CARRAGEENANS SELECTED FROM KAPPA1, KAPPA2, LAMBDA OR IOTA

(76) Inventors: Alejandra Moenne MUÑOZ, Santiago (CL); Jorge Castro Ponce, Santiago (CL); Jeannette Vera Araya, Santiago (CL)

(21) Appl. No.: 12/911,790

(22) Filed: Oct. 26, 2010

(30) Foreign Application Priority Data
Oct. 30, 2009 (CL) 2014-2009

(51) Int. Cl. A01G 17/00; A01G 1/00

(52) U.S. Cl. 47/58.1 FV; 47/58.1 R

(57) ABSTRACT

The invention is related to a method for stimulating carbon fixation in plants by applying an aqueous solution of an oligo-carrageenan selected from the group consisting of kappa1, kappa2, lambda or iota, obtained by acid hydrolysis from commercial pure carrageenans extracted from seaweed. Particularly, a method for stimulating carbon fixation in plant by increasing the net photosynthesis and the activity of the enzyme 1,5 biphophate carboxylase/oxygenase ribluose (Rubisco) in plants. More particularly, it is disclosed a method for stimulating carbon fixation in tobacco, beet or other commercial variety. Even more particularly, a method for stimulating carbon fixation on plants applying by spraying an aqueous solution of such oligo-carrageenans on the plant or parts thereof.

### DESCRIPTIVE MEMORY

The present application is directed to a method that stimulate carbon fixation in plants using an aqueous solution of oligo-carrageenans selected from the group consisting of kappa1, kappa2, lambda or iota, obtained by acid hydrolysis of pure commercial carrageenans extracted from marine algae. In particular, a method to stimulate carbon fixation in plants by enhancing net photosynthesis and activity of ribulose 1,5 biphosphate carboxilase/oxygenase (rubisco) in plants is described. In addition, a method to stimulate carbon fixation in tobacco plants, or in sugar beet plants, or in other plant varieties of commercial interest is presented. Even more particularly, a method to stimulate carbon fixation in plant by spraying a water solution of the mentioned oligo-carrageenans on plants or their parts is mentioned. More particularly, a method to stimulate carbon fixation in plants by spraying a water solution of oligo-carrageenans obtained using the method described in the Chilean patent application No 2369-2007 or its corresponding WO 022221-2009 is described.

### PREVIOUS ART

In the last decades, the exponential growth of human population, the increase of urban and industrial areas, the decrease in cultivable soils due to climate change and aridization and the increase of areas for plant biofuel production (bioethanol and biodiesel) has lead to a progressive decreased cultivable surfaces used for human and animal feeding. Thus, products and/or methods to enhance plant productivity in order to increase plant biomass and the number, size or quality of bulbs, tubers, seeds and fruits are urgently required in order to ensure feeding of future world population.

It is well known, that plant growth and development is mainly determined by photosynthesis. This biological process allows fixation of inorganic carbon (CO₂) into organic molecules required for basal and secondary metabolism in plants. In this process, the energy of light is captured by the green pigment chlorophyll determining the lysis of a water molecule which releases an electron that is transported to photosystem II and photosystem I leading to the synthesis of reducing power (NADPH).

Moreover, the lysis of a water molecule releases a proton generating a gradient that activate ATP synthase which synthesize ATP. Synthesized NADPH and ATP are used as substrates by Calvin cycle enzymes such as ribulose 1,5 biphosphate carboxilase/oxygenase (rubisco) which fixed a CO₂ molecule and incorporate carbon to an organic molecule of three carbons. Thus, the increase in net photosynthesis reflects an increase in carbon fixation, the activation of rubisco and the stimulation of basal and secondary metabolism in plants.

In this century, atmospheric CO₂ has increased from 280 μmol/mol to 380 μmol/mol and will reach 550 μmol/mol in year 2050 (Solomon et al., 2007. Climate change, p. 996, Cambridge University Press, UK). It is now accepted that the increase in atmospheric CO₂ and its adverse effect on climate (greenhouse effect) resides on CO₂ emissions of human industrial activities (antropogenic effect). Thus, the enhancement of carbon fixation by the stimulation of photosynthesis in plants will be highly beneficial to stabilize climate changes reducing aridization of cultivable soils and to increase plant productivity.

Recently, the US Department of Agriculture (USDA) with several research groups performed FACE (Free Air CO₂-Enriched) field experiments in different countries using a high concentration of CO₂ (580 ppm) in order to stimulate carbon fixation in crops and trees (Ainsworth et al, 2008 Next generation of elevated [CO2] experiments with crops: a critical investment for feeding the future world. Plant cell and Environment 31, 1317-1324). However, the yield of wheat, rice and soybean plants increased only in 14% in average instead of 38% as was theoretically predicted. In addition, experiments using classical genetics performed during the past 20 years did not allow the isolation of crop varieties with increased carbon fixation or growth and yield.

Until now, only few agents that stimulate carbon fixation in plants have been reported such as a mixture of brassinosteroids (WO patent application 125069-2008), a lipo-chito-oligosaccharide isolated from Gram negative bacteria of the genus Rhizobium and Bradirhizobium (US patent application 7550068-2007), a chito-oligosaccharide prepared from quitin of arthropods (Chinese patent 1733657-2006), a mixture of short-chain alcohols and aminoacids (US patent 00695-2003) and an alcoholic extract from the plant Impatiens balsamina L. (Japanese patent 10109914-1998).

The present invention shows that oligo-carrageenans obtained by acid depolymerization of pure commercial carrageenans extracted from marine algae prepared following the method described in the Chilean patent application No 2369-2007 and its corresponding WO 022221-2009 stimulate net photosynthesis and the activity of rubisco enzyme in plants, in particular, tobacco plants var. Burley grown in a greenhouse or in the field and sugar beets var. Fidelia grown in a greenhouse.

### SHORT DESCRIPTION OF FIGURES

FIG. 1A: Effect of an aqueous solution of an oligo-carrageenan selected from the group consisting of kappa1, kappa2, lambda and iota on net photosynthesis in tobacco plants var. Burley grown in a greenhouse.

FIG. 1B: Effect of an aqueous solution of an oligo-carrageenan selected from the group consisting of kappa1, kappa2, lambda and iota on rubisco enzyme activity in tobacco plants var. Burley grown in a greenhouse.

FIG. 2A: Effect of an aqueous solution of an oligo-carrageenan selected from the group consisting of kappa1, kappa2, lambda and iota on net photosynthesis in tobacco plants var. Burley grown in field.

FIG. 2B: Effect of an aqueous solution of an oligo-carrageenan selected from the group consisting of kappa2, lambda and iota on rubisco enzyme activity in tobacco plants var. Burley grown in field.

FIG. 3A: Effect of an aqueous solution of an oligo-carrageenan selected from the group consisting of kappa2, lambda and iota on net photosynthesis in sugar beet plants var. Fidelia grown in a greenhouse.

FIG. 3B: Effect of an aqueous solution of an oligo-carrageenan selected from the group consisting of kappa1, kappa2, lambda and iota on rubisco enzyme activity in sugar beet plants var. Fidelia grown in a greenhouse.

### DETAILED DESCRIPTION OF THE INVENTION

Oligo-carrageenans kappa1, kappa2, lambda and iota were prepared by acid depolymerization of pure commercial carrageenans kappa1, kappa2, lambda and iota extracted from seaweed (Gelymar, S. A., Chile) in an aqueous solution containing 0.1N HCl at 60° C. and neutralized with NaOH to pH=7.0.

The greenhouse experiment using tobacco plants was performed with plants var. Burley (n=10) grown in garden bed and then in plastic bags containing compost until they reached the height of 30 cm. Plant leaves were sprayed with water (control) or with an aqueous solution of oligo-carrageenan selected from the group consistent of kappa1, kappa2, lambda and iota at a concentration of 1 mg mL⁻¹, once a week, for three weeks and then grown before flowering.

The field experiment using tobacco plants was performed with plants var. Burley (n=30) grown in garden bed and then in plastic bags containing compost until they reached the height of 15 cm. Plant leaves were sprayed with water (control) or with an aqueous solution of oligo-carrageenan selected from the group consistent of kappa1, kappa2, lambda and iota at a concentration of 1 mg mL⁻¹, once a week, for four weeks and then grown before flowering.

The greenhouse experiment using sugar beet plants was performed with plants var. Fidelia (n=10) grown in plastic bags containing compost until they reached the height of 20 cm. Plant leaves were sprayed with water (control) or with an aqueous solution of oligo-carrageenan selected from the group consistent of kappa2, lambda and iota at a concentration of 1 mg mL⁻¹, once a week, for three weeks and then grown before flowering.

Net photosynthesis was determined in tobacco plants grown in a greenhouse (n=10), tobacco plants grown in field (n=30) and sugar beet plants grown in a greenhouse (n=10) using an InfraRed Gas Analyzer (IRGA, PPsystem, model Ciras-1) and detecting photosynthesis in 5 leaves of each plant.

Rubisco activity was determined in tobacco plants grown in a greenhouse (n=10), tobacco plants grown in field (n=10) and sugar beet plants grown in a greenhouse (n=10) using a protein extract from plant leaves and a coupled enzyme reaction containing phosphoglycerate-kinase (an ATP consuming enzyme) and glyceraldehydes-3 phosphate dehydrogenase (a NADPH consuming enzyme) and determining the decrease in absorbance at 340 nm due to NADPH consumption.

Results showed that net photosynthesis increased in tobacco and sugar beet plants treated with oligo-carrageenans kappa2, lambda and iota. In particular, the highest increase in net photosynthesis was induced by oligo-carrageenan iota in tobacco plants grown in greenhouse, or in the field, and in sugar beet plants and corresponds to 4.3, 4.9 and 1.7 times, respectively. On the other hand, rubisco activity increased in tobacco and sugar beet plants treated with oligo-carragenans kappa1, kappa2, lambda and iota. In particular, the highest increase in rubisco activity was induced by oligo-carrageenan iota in tobacco plants grown in greenhouse, or in the field, and in sugar beet plants and corresponds to 4.4, 4.5 and 5.4 times, respectively. These results indicate that carbon fixation increased in tobacco and sugar beet plants treated with oligo-carrageenans kappa1, kappa2, lambda and iota, mainly with oligo-carrageenan iota. The increase in carbon fixation is due to the increase in net photosynthesis and is reflected by the increase in rubisco activity.

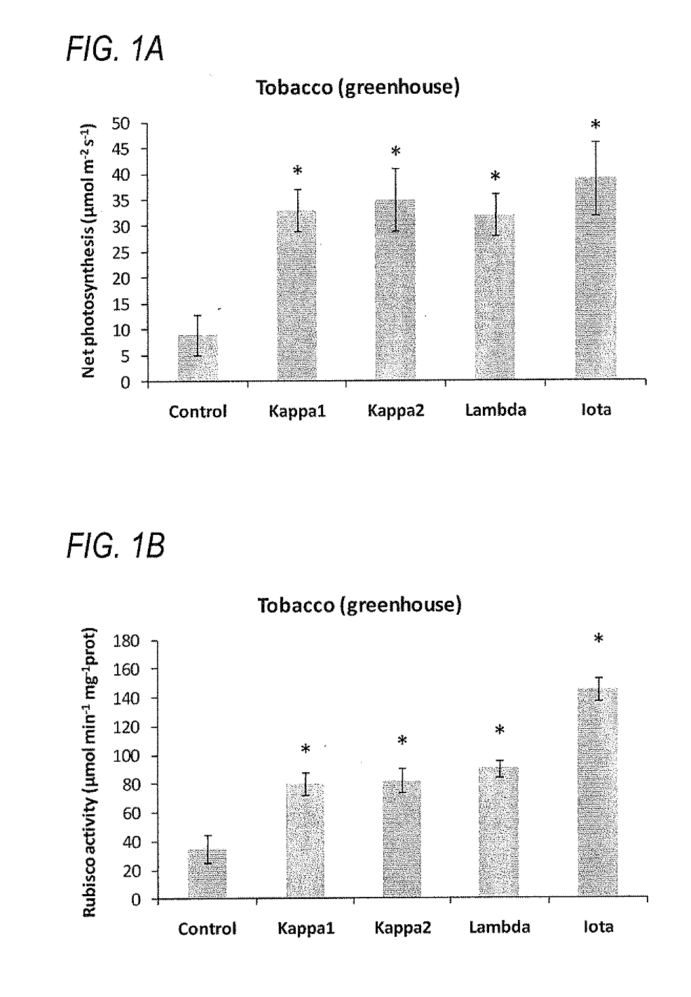

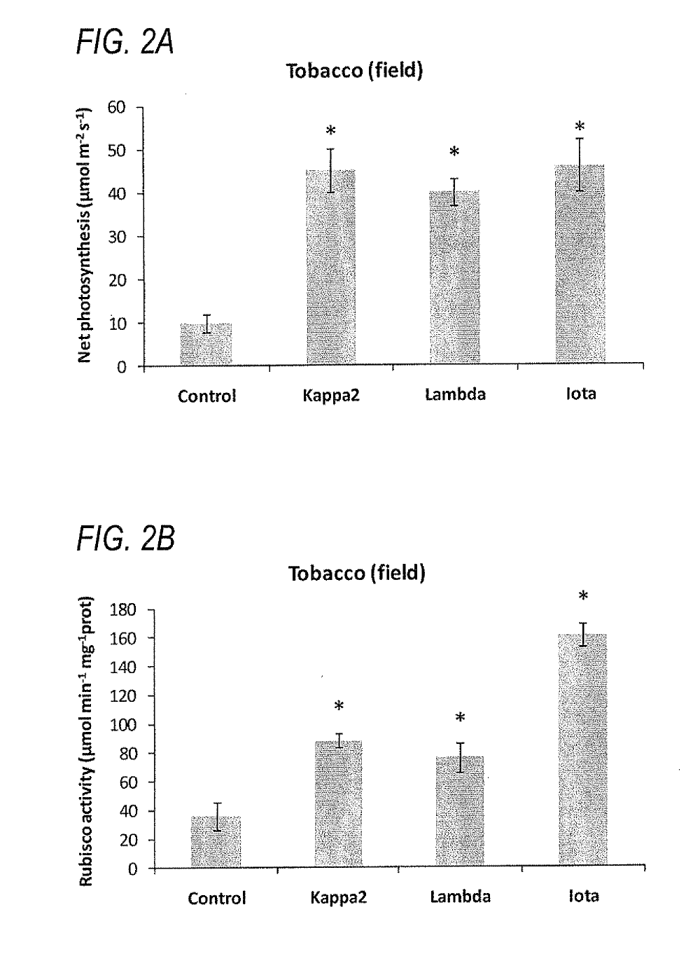

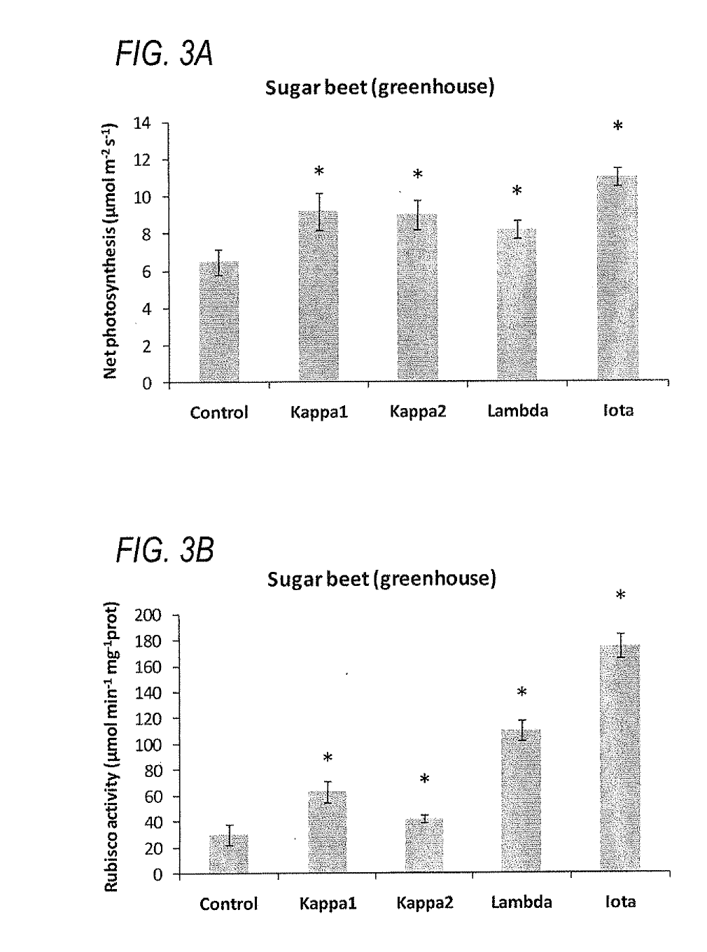

FIG. 1 shows the stimulation of net photosynthesis (FIG. 1A) and the increase in rubisco activity (FIG. 1B) in tobacco plants and treated with an aqueous solution of oligo-carrageenans selected from the group consisting of kappa1, kappa2, lambda or iota and grown in greenhouse. FIG. 2 shows the stimulation of net photosynthesis (FIG. 2A) and the increase in rubisco activity (FIG. 2B) in tobacco plants treated with an aqueous solution of oligo-carrageenans selected from the group consisting of kappa1, kappa2, lambda or iota and grown in field. FIG. 3 shows the stimulation of net photosynthesis (FIG. 3A) and the increase in rubisco activity (FIG. 3B) in sugar beet plants and treated with an aqueous solution of oligo-carrageenans selected from the group consisting of kappa1, kappa2, lambda or iota and grown in greenhouse.

Tables Ito VI show data illustrated in FIGS. 1A, 1B, 2A, 2B, 3A and 3B, the increase in times of net photosynthesis and the increase in specific activity of rubisco enzyme in tobacco and sugar beet plants treated with oligo-carrageenans compared to the control.

TABLE I
Net photosynthesis in tobacco plants grown in a greenhouse and
treated with an aqueous solution of oligo-carrageenans selected
from the group consisting of kappa1, kappa2, lambda or iota and
increase in net photosynthesis compared to the control.

| | Net photosynthesis | |
|---|---|---|
| Treatment | (μmoles m⁻² s⁻¹) | Times of increase |
| Control | 9 ± 4.1 | — |
| Kappa1 | 33.1 ± 5 | 3.7 |
| Kappa2 | 35.7 ± 7.4 | 4 |
| Lambda | 32.5 ± 5.3 | 3.6 |
| Iota | 39.8 ± 8.2 | 4.4 |

TABLE II
Rubisco activity in tobacco plants grown in greenhouse and treated
with an aqueous solution of oligo-carrageenans selected from
the group consisting of kappa1, kappa2, lambda or iota and increase
in net photosynthesis compared to the control.

| | Rubisco activity | |
|---|---|---|
| Treatment | (μmoles min⁻¹ mg⁻¹ protein) | Times of increase |
| Control | 34.5 ± 9.5 | — |
| Kappa1 | 80.7 ± 6 | 2.3 |
| Kappa2 | 82.4 ± 5.6 | 2.4 |
| Lambda | 92.1 ± 5.2 | 2.7 |
| Iota | 148.6 ± 7.9 | 4.3 |

TABLE III
Net photosynthesis in tobacco plants grown in field and treated
with an aqueous solution of oligo-carrageenans selected from
the group consisting of kappa2, lambda or iota and increase
in net photosynthesis compared to the control.

| | Net photosynthesis | |
|---|---|---|
| Treatment | (μmoles m⁻² s⁻¹) | Times of increase |
| Control | 10.1 ± 3.5 | — |
| Kappa2 | 47.2 ± 7.1 | 4.7 |
| Lambda | 43.1 ± 4.6 | 4.3 |
| Iota | 49 ± 8.2 | 4.9 |

TABLE IV
Rubisco activity in tobacco plants grown in field and treated
with an aqueous solution of oligo-carrageenans selected
from the group consisting of kappa2, lambda or iota and
increase in net photosynthesis compared to the control.

| | Rubisco activity | |
|---|---|---|
| Treatment | (μmoles min⁻¹ mg⁻¹ protein) | Times of increase |
| Control | 37 ± 9.6 | — |
| Kappa2 | 91.1 ± 4.9 | 2.5 |
| Lambda | 75 ± 9.9 | 2 |
| Iota | 165.6 ± 7.7 | 4.5 |

TABLE V
Net photosynthesis in sugar beet plants grown in a greenhouse
and tretade with an aqueous solution of oligo-carrageenans selected
from the group consisting of kappa1, kappa2, lambda or iota and
increase in net photosynthesis compared to the control.

| | Net photosynthesis | |
|---|---|---|
| Treatment | (μmoles m⁻² s⁻¹) | Times of increase |
| Control | 6.6 ± 40.5 | — |
| Kappa1 | 9.4 ± 1.1 | 1.4 |
| Kappa2 | 9.2 ± 0.9 | 1.4 |
| Lambda | 8.9 ± 0.5 | 1.3 |
| Iota | 11.3 ± 0.4 | 1.7 |

TABLE VI
Rubisco activity in sugar beet plants grown in greenhouse and
treated with an aqueous solution of oligo-carrageenans selected
from the group consisting of kappa1, kappa2, lambda or iota and
increase in net photosynthesis compared to the control.

| | Rubisco activity | |
|---|---|---|
| Treatment | (μmoles min⁻¹ mg⁻¹ protein) | Times of increase |
| Control | 32.5 ± 7.3 | — |
| Kappa1 | 68 ± 8.4 | 2.1 |
| Kappa2 | 47.7 ± 4.6 | 1.5 |
| Lambda | 110.2 ± 7.2 | 3.4 |
| Iota | 173.9 ± 9.9 | 5.4 |

What is claimed is:

1. Method for stimulating carbon fixation in plants comprising spraying on plants or parts thereof an aqueous solution of an oligo-carrageenan selected from the group consisting of kappa1, kappa2, lambda or iota.

2. The method of claim 1, wherein the oligo-carrageenan is selected from the group consisting of kappa2, lambda or iota.

3. The method of claim 2, wherein the oligo-carrageenan is iota.

4. The method of claim 1, wherein the oligo-carrageenans are prepared by depolymerization in an acid media (0.1 N HCl) and at hot environment (60° C.) from pure commercial carrageeneans kappa1, kappa2, lambda y iota extracted from seaweed.

5. The method of claim 1 wherein the plants are selected from a greenhouse or a field of growing plants.

6. The method of claim 2, wherein the plants are selected from a greenhouse or a field growing tobacco plants.

7. The method of claim 3, wherein the plants are selected from a greenhouse or a field of growing plants.

8. The method of claim 5, wherein the plant is selected from tobacco or beet.

9. The method of claim 6, wherein the plant is selected from a greenhouse growing tobacco or beet plant.

10. The method of claim 2, wherein the plant is selected from a field growing tobacco plants.

11. The method of claim 3, wherein the plant is selected from a field growing tobacco plants.

12. The method of claim 8, wherein the aqueous solution of align-carrageenan is sprayed on the leaf of the tobacco or beet plant.

13. The method of claim 1, wherein the aqueous solution of oligo-carrageenans has a concentration of 1 mg mL⁻¹.

14. The method of claim 1, wherein the aqueous solution of oligo-carrageenan is sprayed weekly or a total of three times during growing and before flowering.

15. The method of claim 5, wherein the aqueous solution of oligo-carrageenan is sprayed weekly or a total of three times during growing and before flowering.

16. The method of claim 1, wherein the aqueous solution of oligo-carrageenan is sprayed weekly or a total of four times before being transferred to a field and growing up to flowering.

17. The method of claim 5, wherein the aqueous solution of oligo-carrageenan is sprayed weekly or a total of four times before being transferred to a field and growing up to flowering.

18. The method of claim 10, wherein the aqueous of oligo-carrageenan is sprayed weekly or a total of four times before being transferred to a field and growing up to flowering.
